(19) United States
(12) Patent Application Publication
(10) Pub. No.: US 2017/0363786 A1
(43) Pub. Date: Dec. 21, 2017

(54) FILM TYPE IRAF FILTER AND THE MANUFACTURING METHOD THEREOF

(71) Applicant: Platinum Optics Technology Inc., Taoyuan (TW)

(72) Inventors: Hsin-Miau PENG, Taoyuan (TW); Xue-Guang CHEN, Taoyuan (TW)

(21) Appl. No.: 15/367,566

(22) Filed: Dec. 2, 2016

(30) Foreign Application Priority Data
Jun. 17, 2016 (TW) 105119079

(51) Int. Cl. G02B 5/20; B05D 5/06; B05D 7/00; G02B 1/10

(52) U.S. Cl. CPC G02B 5/208; G02B 1/10; B05D 5/06; B05D 7/584

(57) ABSTRACT

A film type IRAF filter and the manufacturing method thereof are disclosed. A method for manufacturing a film type IRAF filter includes steps of: providing a first carrier trimmed to a predetermined size in advance; forming a first substrate on the first carrier; forming an intermedia layer on a first surface of the first substrate; forming an Infrared-absorbing filter dye layer on the intermedia layer; forming a first multi-layers optical film on the Infrared-absorbing filter dye layer; forming a release layer on the first multi-layers optical film; removing the first carrier to expose a second surface opposite the first surface of the first substrate; forming a second multi-layers optical films on the second surface of the first substrate; and removing the release layer.

### FIELD OF THE INVENTION

The present invention relates to a filter and more specifically to a film type IRAF filter and the manufacturing method thereof.

### BACKGROUND OF THE INVENTION

Traditionally, COP (Cyclo Olefin Polymer) and COC (Cyclo Olefin Co-Polymer) are adopted for an underlying for the thin-film substrate manufacturing process of non-glass underlying super-thin optical IRAF filter, and the substrate has a 50 μm or 100 μm thickness. Serious deformation may occur on such organic substrate after baking and film-plating process according to the too thin thickness thereof, therefore causing problems of low manufacturing yield and increasing cost.

For manufacturing film type IRAF filter, the Roll to Roll (R2R) process is adopted. The Roll to Roll process is that performing processes including coating the primer, coating IR dye (Anti-Infrared) and optical coating on the roll-like manufactured COP and CPC thin film having barrier layers on the both side thereof via an R2R apparatus in sequence. After completing the processes, the optical filter can be trimmed depending on the desirable size, and then a defect inspection can be performed on the optical filter. In the conventional R2R process, a pulling force is loaded on the optical filter, and a tensile stress may be easily remained in the optical filter.

The manufacturing method has some problems such as complicated process, low yield and not easy to clean. In additional, as for the raw material of the thin film, the bought raw material of the thin film may have clean-requirement and static electricity issues, therefore further lowering the manufacturing yield.

Accordingly, the manufacturing firms manufacturing the film type IRAF filter are looking forward to developing a film type IRAF filter having uncomplicated processes, high-level cleanliness and being deformation-free.

### SUMMARY OF THE INVENTION

To achieve aforesaid objects, the present application provides a method for manufacturing a film type IRAF filter, which using twice carrier-transferring technology to manufacture the film type IRAF filter. Firstly, a glass or metal carrier trimmed to a predetermined size is adopted for a first carrier, and after plating a multi-layers film on a first surface, a release layer is adopted for a second carrier configured to plate another multi-layers films on a second surface opposite the first surface. Therefore special technical effects such as uncomplicated manufacturing processes, easy to clean, high yield and well optical feature are achieved.

The present application provides a method for manufacturing a film type IRAF filter, including: providing a first carrier trimmed to a predetermined size; forming a first substrate on the first carrier; forming an intermedia layer on the first substrate; forming an Infrared-absorbing dye layer on the intermedia layer; forming a first multi-layers optical film on the Infrared-absorbing dye layer; forming a release layer on the first multi-layers optical film; removing the first carrier to expose the other surface of the first substrate; forming a second multi-layers optical film on the other surface of the first substrate; and removing the release layer.

The present application further provides a film type IRAF filter, including: a first substrate having a predetermined size; an intermedia layer formed on a first surface of the first substrate; an Infrared-absorbing dye layer formed on the intermedia layer; a first multi-layers optical film formed on the Infrared-absorbing dye layer; and a second multi-layers optical film formed on a second surface of the first substrate.

To make the aforesaid and other objects, features and advantages of the present invention can be more apparent and easier to be understood, some embodiments are introduced in following quotes, and in together with the accompanying drawings to make a detailed description below.

### BRIEF DESCRIPTION OF THE DRAWINGS

FIGS. 1A and 1B show a specific embodiment of a method for manufacturing a film type IRAF filter of the present application.

FIGS. 2A to 2G are schematic diagrams in a cross-sectional view of a method for manufacturing a film type IRAF filter of the present application.

### DETAILED DESCRIPTION OF THE INVENTION

### Definitions

According to an embodiment of the present application, a twice carrier-transferring technology is used to manufacture the film type IRAF filter in the present application. Firstly, a glass or metal carrier trimmed to a predetermined size is adopted for a first carrier, and after plating a multi-layers film on a first surface, a release layer is adopted for a second carrier configured to plate another multi-layers films on a second surface opposite the first surface. Therefore special technical effects such as uncomplicated manufacturing processes, easy to clean, high yield and well optical feature are achieved. Some embodiments are presented below to explain the specific methods of the present application.

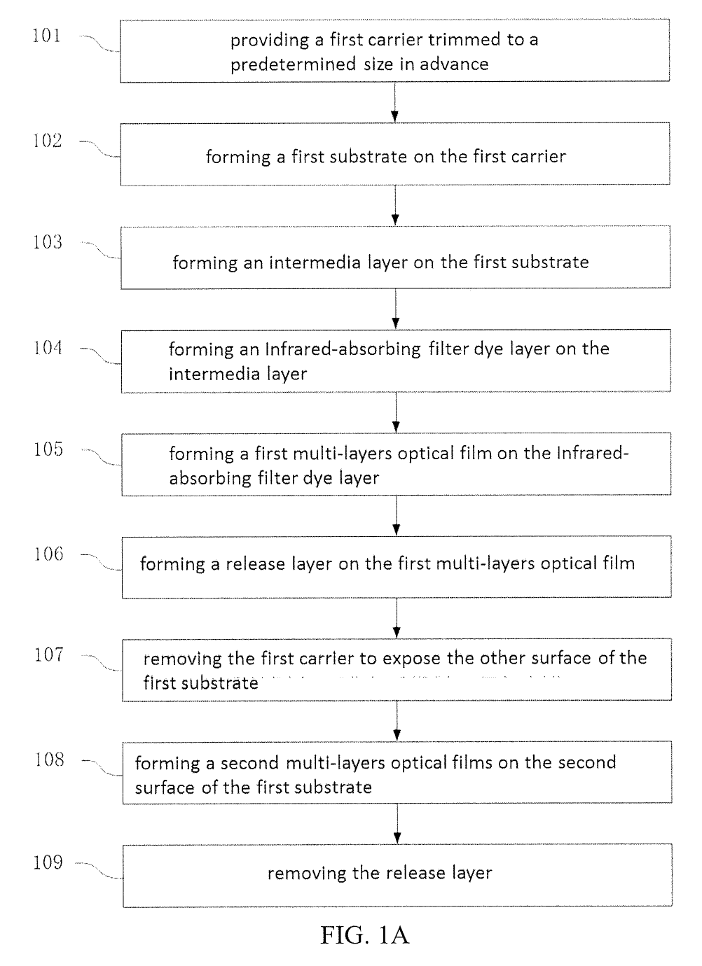

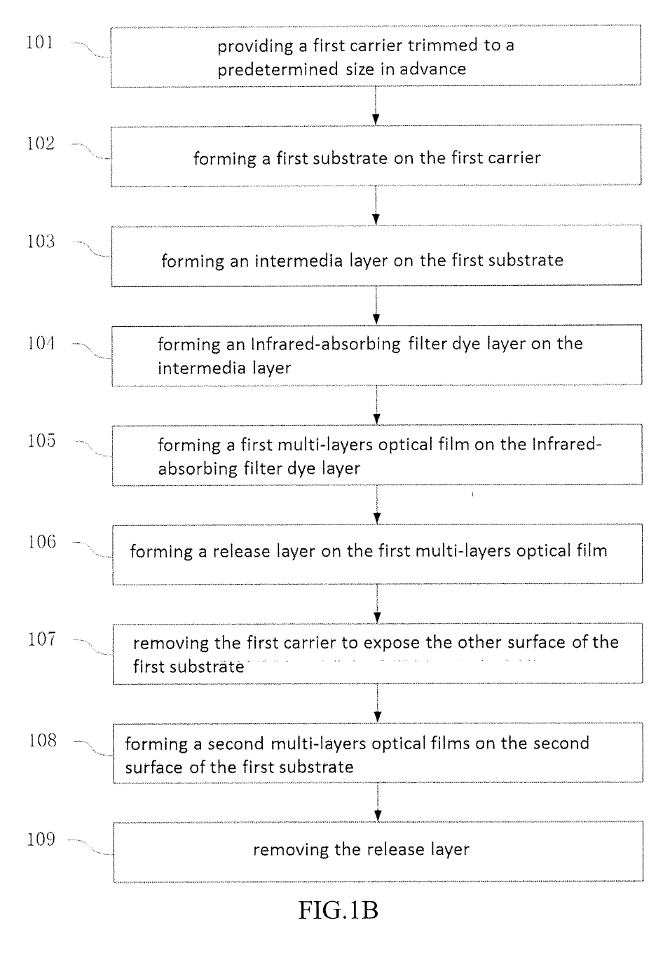

Firstly, please referring to FIG. 1A, a specific embodiment of a method for manufacturing a film type IRAF filter of the present application includes steps of:

Step 101: Providing a first carrier trimmed to a predetermined size. The difference between the present application and conventional art is that the first carrier is trimmed in advance for a desirable size. In other words, in the present application the first carrier including a glass or metal carrier is trimmed in advance instead of a post-trimming method fabricating a large piece of optical filter before trimming. In this way, the film type IRAF filter can be manufactured after finishing the multi-layers film process and bypass the trimming process.

Step 102: forming a first substrate on the first carrier, wherein the first carrier can be a glass or metal carrier, and the first substrate can be a glass substrate or plastic film. That is, the preset step is that forming a plastic film on a glass carrier or a metal carrier, or forming a glass substrate on a metal carrier. In other words, a technical feature of the present application is that serve the first carrier trimmed in advance as a carrier for forming different material thereon by using various methods, therefore the first substrate can have a fixed size corresponding to the first carrier. The material of the first substrate can include plastic material or glass, and the first carrier can be formed depending on the material feature. For example, plastic or glass material can be formed on a metal carrier; as for a glass carrier, a plastic material can be preferably formed thereon. If a plastic material is adopted to be formed on the first carrier, a liquid plastic coating technology can be adopted to form the first substrate whether the first carrier is a metal carrier or a glass carrier. The adopted plastic material can be coated in liquid phase and then solidified, for example, the first substrate can be liquid Polyamide. The first substrate formed by coating liquid material on the first carrier can have excellent uniformity. The coating thickness of the first substrate can be controlled resulting from using a liquid material to perform coating. In comparison with the conventional R2R manufacturing process, the first carrier of the present application is served as a carrier to form the first substrate therefore the stability of subsequent processes can be raised.

Step 103: forming an intermedia layer on the first substrate. The intermedia layer can include Primer. The intermedia layer can make it easier to form the subsequent Infrared-absorbing coating layer. The intermedia layer can include trimethoxy based material to be formed on a glass carrier due to having better adhesion with the glass carrier. Other carriers and substrates in together therewith can adopt corresponding intermedia layer, and it's not necessary to make extra description.

Step 104: forming an Infrared-absorbing filter dye layer on the intermedia layer, and the Infrared-absorbing optical film can be formed by coating the Infrared-absorbing filter dye on the intermedia layer.

Step 105: forming a first multi-layers optical film on the Infrared-absorbing filter dye layer. The first multi-layers optical film can be plated in accordance with the design demand such as anti-reflection, barrier layer etc.

Step 106: forming a release layer on the first multi-layers optical film. The first substrate and a multi-layers Infrared-absorbing optical layer including the intermedia layer, the Infrared-absorbing filter dye layer and the first multi-layers optical film are between the release layer and the first carrier, and a sandwich structure can be formed.

Step 107: removing the first carrier to expose the first substrate. The release layer can serve as a second carrier after removing the first carrier. The difference between the release layer and first carrier is that there is no need for the release layer to be made to a predetermined size.

Step 108: forming a second multi-layers optical film on the other surface of the first carrier. The second multi-layers optical film can be plated in accordance with the design demand such as anti-reflection or protection layer.

Step 109: removing the release layer. Accordingly a film-type multi-layers optical filter being the film type IRAF filter can be formed.

Emphatically, even introducing different kinds of material of the carriers and the first substrate, the technical effects including high quality, short manufacturing period and low cost of the film type IRAF filter of the present application can be also achieved based on the technical features of first carrier pre-trimming and twice carrier-transferring technology. A specific embodiment of is listed in the following quotes to describe a flow of FIG. 1A of the present application.

Please referring to FIG. 1B, a method for manufacturing a film type IRAF filter of the present application is disclosed. In the embodiment a glass carrier is served as the first carrier, and a plastic film is served as the first substrate. Furthermore, the plastic film can be formed by a plastic material produce including liquid-coating and solidifying. For example, coating liquid Polyamide film and then solidifying it. The method including steps of:

Step 111: Providing a glass carrier trimmed to a predetermined size in advance, different from that of the conventional art, the size of the glass carrier is restricted to a desirable size via trimming the glass carrier in advance. In other words, in the present application the glass carrier is trimmed in advance before fabricating the large piece of optical filter instead of a post-trimming method fabricating a large piece of optical filter before trimming. In this way, a film-type multi-layers optical filter can be manufactured without trimming.

Step 112: forming a PI (Polyamide) film on the glass carrier, that is, in a step of forming a plastic film on the glass carrier, and in an embodiment the plastic material can include Polymide. PI film can be formed by coating liquid PI material for an excellent uniformity. The thickness of a liquid PI can be controlled. Comparing to the conventional R2R process, the stability of subsequent processes of present application can be raised via using a glass carrier to be the carrier.

Step 113: forming an intermedia layer on the PI film. The intermedia layer can be a Primer. The subsequent IR coating layer can be more easily formed after coating the intermedia layer. The intermedia layer can be formed by a trimethoxy based material.

Step 114: forming an Infrared-absorbing filter dye layer on the intermedia layer, and the Infrared-absorbing optical film can be formed by coating the Infrared-absorbing filter dye on the intermedia layer

Step 115: forming a first multi-layers optical film on the Infrared-absorbing filter dye layer. The first multi-layers optical film can be plated in accordance with the design demands such as anti-reflection, barrier layer, etc.

Step 116: forming a release layer on the first multi-layers optical film. The plastic film and a multi-layers Infrared-absorbing optical layer including the intermedia layer, the Infrared-absorbing filter dye layer and the first multi-layers optical film are between the release layer and the glass carrier, and a sandwich structure can be formed.

Step 117: removing the release layer to expose the PI film. The release layer becomes the second carrier after removing the glass carrier. The difference between the release layer and the first carrier (glass carrier) is that there is unnecessary for release layer to be formed according to a predetermined size.

Step 118: forming a second multi-layers optical film on the other surface of the PI film. The second multi-layers optical film can be plated in accordance with the design demands such as anti-reflection, barrier layer, etc.

Step 119: removing the release layer. Accordingly a film-type multi-layers optical filter being the film type IRAF filter can be formed.

It's can be figured out that the pre-trimmed first carrier, including a glass carrier or metal carrier is applied to the manufacturing process of the present application, so the first substrate can be formed with a predetermined size the same with that of the first carrier instead of processing post-trimming after completing the subsequent manufacturing process of the film-type multi-layers optical filter. The manufacturing yield can be raised by devoid of the conventional R2R situation during entire period of fabricating process. Cleaning becomes easier result from the first carrier/release layer (second carrier) serving as carriers during fabricating process. The large apparatus of R2R is not needed by the present application, therefore decreasing the cost. As a whole, the present application includes features such as simple fabricating process, raised yield and greatly lowered cost.

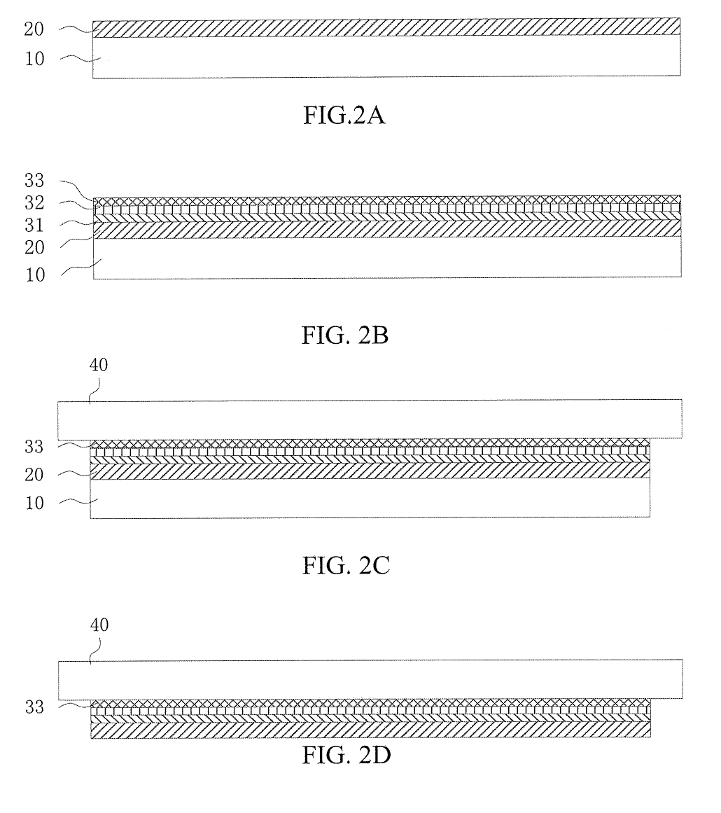

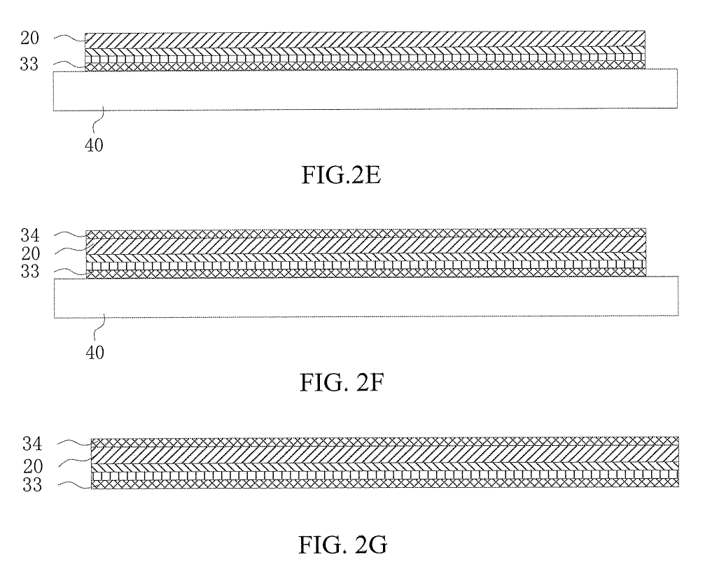

Please referring to FIGS. 2A to 2G, a schematic glow diagrams in a cross-sectional view of a method for manufacturing a film type IRAF filter of the present application is shown, and the diagram is according to FIG. 1B.

As shown in FIG. 2A, the steps 101 to 102 are disclosed. The material of the first substrate is formed on the first carrier therefore the first substrate is formed. Accordingly, the size of the first substrate 20 is the same with that of the first carrier.

As shown in FIG. 2B, the steps 103 to 105 are disclosed. An Infrared-absorbing optical film is formed by sequentially forming a premier (including the intermedia layer), an Infrared-absorbing filter dye layer 32 and a first multi-layers optical film 33 on the first substrate 20.

As shown in FIG. 2C, the step 106 is disclosed. A release layer 40 is formed on the first multi-layers optical film 33.

As shown in FIG. 2D, the step 107 is disclosed. After removing the glass carrier 10, the release layer 40 becomes a second carrier for subsequent plating process.

As shown in FIG. 2E, a semi-finished product of a film type IRAF in step 107 is reversed.

As shown in FIG. 2F, the step 108 is disclosed. A second multi-layers optical film is formed on the other surface of the first substrate.

As shown in FIG. 2G, the step 109 is disclosed. A film type IRAF filter of the present application can be manufactured after removing the release layer 40. Accordingly, a film type IRAF filter of the present application includes: a first substrate having a predetermined size; an intermedia layer formed on a first surface of the first substrate; an Infrared-absorbing filter dye layer formed on the intermedia layer; a first multi-layers optical film formed on the Infrared-absorbing filter dye layer; and a second multi-layers optical film formed on a second surface of the first substrate; wherein the first substrate can include a plastic film or a glass carrier. In additional, the plastic film can be formed by coating a liquid plastic material and the solidifying it, for example, the plastic film can include PI film.

According to the description corresponding to FIGS. 1A and 2, it's can be understood that the concept of the present application is to form films on the first carrier 10 via coating liquid PI material thereon. The first carrier 10 is the carrier for the first substrate being performed posterior processes including dye-coating, baking, optical plating and lifting-off after cleaning for acquiring the new design of manufacturing process of the final product. Moreover, when the first carrier 10 is used to be the forming carrier of the first substrate, the size of film is just the same with that of the first carrier, therefore the posterior process of trimming or splitting can be abbreviated.

In the embodiment of adopting a glass carrier as the first carrier and a PI film as the first substrate, the film-type multi-layers optical filter manufactured according to the new manufacturing method adopted by the present application has apparent enhancement on Transmittance and Haze. According to the analysis, by using the new manufacturing method of the present application, the cleanliness of the film-type multi-layers optical filter is raised to make a contribution for the enhancement. The specific differences are shown as the following table:

| | Transmittance | Haze | Parallel Transmittance |
|---|---|---|---|
| The present | 89.11 | 0.19 | 88.94 |
| application | | | |
| R2R | 88.96 | 3.61 | 85.75 |

In conclusion, the technical features of the present application includes: 1. Effectively solving a series of manufacturing problems caused by substrate-deforming during the manufacturing process of the super-thin organic substrate used by the industry, and saving the working time of holding the film in the plating fixture so as to avoiding problems such as leading pollution and deformation of film underlying after having be rolled up for a long period; 2. solving a problem of bad cleanliness of original material, that's to say, avoiding the pollution of barrier film after the film underlying of the original material being rolled up, therefore raising the optical features including Transmittance and Haze; 3. It's easy to clean after every-time plating, because the glass carrier provides supporting to the film underlying after being the carrier of the plastic film, therefore overcoming the difficulty of cleaning during the subsequent plating; 4. It's unnecessary to invest an expensive R2R manufacturing apparatus, therefore reducing apparatus cost and further reducing the cost of a unit of the product; 5. In the conventional R2R process, a specific pulling force is loaded on the film underlying from rolling up after casting to plating, and a tensile stress may be easily remained in the film underlying, however, by using the new manufacturing method of the present application, the tensile stress is not easily remained in the material; 6. when the glass carrier is used to be the forming carrier of the plastic film, the formed plastic film has a size just the same with that of the first carrier, therefore the posterior process of trimming or splitting can be abbreviated, not only avoiding reducing yield but also reducing production flow.

Although the present application has been explained above, it is not the limitation of the range, the sequence in practice, the material in practice, or the method in practice. Any modification or decoration for present application is not detached from the spirit and the range of such.

What is claimed is:

1. A method for manufacturing a film type IRAF filter, comprising steps of:
providing a first carrier trimmed to a predetermined size in advance;
forming a first substrate on the first carrier;
forming an intermedia layer on a first surface of the first substrate;
forming an Infrared-absorbing filter dye layer on the intermedia layer;
forming a first multi-layers optical film on the Infrared-absorbing filter dye layer;
forming a release layer on the first multi-layers optical film;
removing the first carrier to expose a second surface opposite the first surface of the first substrate;
forming a second multi-layers optical films on the second surface of the first substrate; and
removing the release layer.

2. The method for manufacturing a film type IRAF filter according to claim 1, wherein the first substrate comprises a plastic film or a glass substrate.

3. The method for manufacturing a film type IRAF filter according to claim 2, wherein the plastic film is formed by comprising steps of: coating a liquid plastic material on the first carrier; and solidifying the liquid plastic material.

4. The method for manufacturing a film type IRAF filter according to claim 1, wherein the first carrier comprises a glass carrier or a metal carrier.

5. The method for manufacturing a film type IRAF filter according to claim 4, wherein the step of forming the first substrate on the first carrier comprises coating a liquid Polymide (PI) on the first carrier.

6. The method for manufacturing a film type IRAF filter according to claim 4, wherein the step of forming the first substrate on the first carrier comprises forming a plastic film on the glass carrier.

7. The method for manufacturing a film type IRAF filter according to claim 1, wherein the step of forming the first substrate on the first carrier comprises forming a plastic film on the first carrier.

8. The method for manufacturing a film type IRAF filter according to claim 4, wherein the step of forming the first substrate on the first carrier comprises forming a glass substrate or a plastic film on the glass carrier.

9. The method for manufacturing a film type IRAF filter according to claim 1, wherein the step of forming the first substrate on the first carrier comprises forming a glass substrate or a plastic film on the first carrier.

10. A film type IRAF filter manufactured according to the method of claim 1, comprising:
a first substrate comprising a predetermined size;
an intermedia layer formed on a first surface of the first substrate;
an Infrared-absorbing filter dye layer formed on the intermedia layer;
a first multi-layers optical film formed on the Infrared-absorbing filter dye layer; and
a second multi-layers optical film formed on a second surface of the first substrate.

11. The film type IRAF filter according to claim 10, wherein the first substrate comprises a plastic film or a glass substrate.

12. The film type IRAF filter according to claim 11, wherein the plastic film is formed by coating a liquid plastic material on the first carrier and solidifying the liquid plastic material.
